(19) United States
(12) Patent Application Publication
(10) Pub. No.: US 2025/0137090 A1
(43) Pub. Date: May 1, 2025

(54) Compositions and processes for the extraction of metals using non-aqueous solvents

(71) Applicant: ARGO NATURAL RESOURCES LIMITED, London (GB)

(72) Inventors: Robert HARRIS, Syston (GB); Gawen JENKIN, Great Glen (GB)

(21) Appl. No.: 18/694,278

(22) PCT Filed: Sep. 26, 2022
(86) PCT No.: PCT/GB2022/052433

§ 371 Date: Mar. 21, 2024

(30) Foreign Application Priority Data
Sep. 27, 2021 (GB) 2113800.3

(51) Int. Cl. C22B 7/00; C22B 3/00; C22B 3/22; C22B 11/00; C22B 15/00; C22B 21/00; C22B 25/06

(52) U.S. Cl. CPC C22B 7/008; C22B 3/22; C22B 11/046; C22B 13/045; C22B 15/0078; C22B 15/0086; C22B 19/24; C22B 21/0023; C22B 23/0446; C22B 23/0453; C22B 25/04; C22B 25/06

(57) ABSTRACT

The present invention relates to compositions and processes for the extraction of metals from solid material using non-aqueous solvents and oxidisers. The processes and compositions of the present invention are useful for selectively extracting metals from solid material, particularly electronic waste material.

### FIELD OF THE INVENTION

The present invention relates to compositions and processes for the extraction of metals from solid material using Deep Eutectic Solvents (DESs) and oxidisers. The processes and compositions of the present invention are useful for selectively extracting metals from solid material, particularly electronic waste material.

### BACKGROUND TO THE INVENTION

Deep Eutectic Solvents (DESs) are formed by the complexation of certain components to provide an homogeneous mixture that melts at a single temperature that is lower than the melting point of any of the constituent components. Examples of components that can be complexed to form DESs are quaternary ammonium salts and hydrogen bond donors.

Following their discovery, DESs found a number of applications, including in the dissolution of metal oxides and chlorides. In this regard, WO 02/26701 A2 discloses the preparation of a variety of DESs and their use as battery electrolytes, solvents for metal oxides, components for electropolishing and the electrodeposition of metals, and solvents for chemical reactions.

It was later discovered that native metals such as gold, silver, copper, nickel, tin, lead, aluminium, iron etc. could be dissolved when the DES was combined with an oxidizer in the form of iodine (see Abbott et al., Electrocatalytic recovery of elements from complex mixtures using deep eutectic solvents, Green Chem., 2015, 17, pp 2172-2179). Iodine is poorly soluble in water, making it unsuitable for most aqueous chemistries. However, it is highly soluble in DESs and, once solubilized, it is capable of oxidising a wide range of metals.

The ability of DESs to dissolve native metals has potential applications in the field of metal extraction where, currently, hydrometallurgical processes, which often use strong mineral acids or poisonous chemicals such as cyanide or mercury, and energy-intensive pyrometallurgical processes are used.

The use of DESs in combination with iodine to dissolve native metals does have disadvantages, however. These include the high cost of iodine, its relatively low metal selectivity due to its ability to oxidise a wide range of metals, and its sensitivity to additional water.

In the light of the above, there is a need for compositions comprising a DES and an oxidiser that addresses these disadvantages. Additionally, there is a need for processes for the extraction of metals from solid material that has improved selectivity for certain metals, thus simplifying the post-process recovery of these metals. This is particularly the case for the extraction of metals from high-value components of electronic waste (e-waste) such as printed circuit boards (PCBs), Central Processing Units (CPUs) and Random Access Memory (RAM), where recovery of the high-value metals such as gold is complicated by the presence of other metals.

### SUMMARY OF THE INVENTION

The present invention addresses and overcomes the disadvantages of the prior art by providing a composition for extracting metals from solid material comprising a DES and an oxidiser. This composition is capable of dissolving many metals, but may be incapable of dissolving some metals, including gold. The present invention also provides a process for the extraction of metals from solid material that uses this composition.

In addition to the above, the present invention provides a two-step process for the extraction of metals from solid material, in which the solid material is first contacted with a composition comprising a DES and a first oxidiser, and, in a second step, contacted with a composition comprising a DES and a second oxidiser, wherein the first oxidiser and the second oxidiser are different.

Viewed from a first aspect, the present invention is directed to a process for the extraction of one or more metals from a solid material, the process comprising:
(i) a first leaching step comprising contacting the solid material with a first leaching solution comprising:
a first deep eutectic solvent (DES) formed by the reaction of a first quaternary ammonium salt and a first hydrogen bond donor in a molar ratio of from 4:1 to 1:20; and,
a first oxidiser,
thereby providing a first leached solid material and a first liquid phase;
(ii) a second leaching step comprising contacting the first leached solid material with a second leaching solution comprising:
a second DES formed by the reaction of a second quaternary ammonium salt and a second hydrogen bond donor in a molar ratio of from 4:1 to 1:20; and,
a second oxidiser,
thereby providing a second leached solid material and a second liquid phase;
wherein the first oxidiser and the second oxidiser are different.

Viewed from a second aspect, the present invention is directed to a process for the extraction of one or more metals from a solid material, the process comprising:
(i) a leaching step comprising contacting the solid material with a leaching solution comprising:
a deep eutectic solvent (DES) formed by the reaction of a quaternary ammonium salt and a hydrogen bond donor in a molar ratio of from 4:1 to 1:20; and,
a first oxidiser;
wherein the reduction potential of the first oxidiser is less than or equal to +0.50V and/or wherein the first oxidiser is an Fe(III) salt, a Cu(II) salt, a Te(IV) salt, a Cr(III) salt, or a Mn(VII) salt.

Viewed from a third aspect, the present invention is directed to a composition for extracting one or more metals from a solid material comprising:
a deep eutectic solvent formed by the reaction of a first quaternary ammonium salt and a first hydrogen bond donor in a molar ratio of 4:1 to 1:20; and
a first oxidiser;
wherein the reduction potential of the first oxidiser is less than or equal to +0.50V and/or wherein the first oxidiser is an Fe(III) salt, a Cu(II) salt, a Te(IV) salt, a Cr(III) salt, or a Mn(VII) salt.

Preferable features of the present invention are set out in the dependent claims presented below.

### BRIEF DESCRIPTION OF THE FIGURES

FIG. 1A shows the depth to which deposits of Cu, Ni and Au on a resin are etched by submerging the resin in a DES comprising choline chloride and ethylene glycol in a 1:2 stoichiometric ratio (known in the art as E200)+1M FeCl₃ according to Example 1.

FIG. 1B shows the depth to which deposits of Cu, Ni and Au on a resin are etched by submerging the resin in E200+0.5M I₂ according to Example 1.

FIGS. 2-5 show the normalised percentage of each metal leached during the leaching process described in Example 2.

FIG. 6 shows the percentage mass lost during treatment of E-waste with different oxidisers at different temperatures according to Example 3.

FIG. 7 shows the effect of temperature, water content, DES:solid ratio and time on leaching <1.2 mm E-waste according to Example 4.

FIG. 8 shows the normalised percentage of each metal leached during the leaching process described in Example 5.

### DETAILED DESCRIPTION OF THE INVENTION

The present inventors have identified a composition comprising a DES and an oxidiser and a process for the extraction of one or more metals from a solid material using this composition. This composition demonstrates high oxidiser solubility and is capable of dissolving many metals (including the majority of the metals that are commonly present in electronic solid waste material), but the composition is incapable of dissolving some metals, including gold. A process for the extraction of metals from solid material that uses this composition provides a gold-rich solid material after the solid material has been contacted with the composition.

The present inventors have additionally developed a two-step process for efficiently and selectively extracting metals from solid material, which comprises a first step of contacting the solid material with the composition comprising a DES and a first oxidiser. The material remaining after contacting the solid material with this composition is rich in the metals that are not dissolved in the first step. In the second step, the solid material from the first step is contacted with a composition comprising a DES and a second oxidiser, which is different from the first oxidiser. The second step may dissolve the metals that remained in the solid material after the first step. As is clear from the language used herein, the present invention is not limited to two steps of treatment with a DES and an oxidiser and may include one or more additional such steps using the same or different DESs and oxidisers performed before, during, and/or after the steps described herein.

DESs are non-aqueous solvents, which means that the compositions and processes of the present invention have very low water consumption. The low vapour pressure of DESs also means that the processes can be run at elevated temperatures without producing high quantities of volatile organic compounds or particulate emissions and with minimal loss of solvent due to evaporation. Their relatively benign nature means that DESs are user friendly.

The present invention achieves a low carbon, low energy and environmentally benign method for the processing of metal-containing solid material such as electronic-waste (e-waste) or waste electrical and electronic equipment (WEEE). The process can replace environmentally damaging hydrometallurgical processes, which often use strong mineral acids or poisonous chemicals such as cyanide or mercury, and energy-intensive pyrometallurgical processes that are commonly used to recycle such materials. Furthermore, the present invention achieves high metal recoveries from polymetallic feedstock and is capable of complex metal recovery at relatively low cost compared to capital-intensive pyrometallurgical processes.

In addition to the above advantages, the two-stage process of the present invention provides an efficient and selective process for the recovery of valuable metals contained within solid material and produces either single element metal products or mixed metal products that can be tailored to meet market needs.

### Definitions

Oxidisers-When specific compounds are referred to herein as oxidisers (e.g. FeCl₃), this refers to the oxidiser in the form in which it is added to the composition, because the counterion (e.g. Cl) may change once the oxidiser has dissolved in the DES.

When viewed from a first aspect, the present invention provides a process for the extraction of one or more metals from a solid material, the process comprising:
(i) a first leaching step comprising contacting the solid material with a first leaching solution comprising:
a first deep eutectic solvent (DES) formed by the reaction of a first quaternary ammonium salt and a first hydrogen bond donor in a molar ratio of from 4:1 to 1:20; and,
a first oxidiser,
thereby providing a first leached solid material and a first liquid phase;
(ii) a second leaching step comprising contacting the first leached solid material with a second leaching solution comprising:
a second DES formed by the reaction of a second quaternary ammonium salt and a second hydrogen bond donor in a molar ratio of from 4:1 to 1:20; and,
a second oxidiser,
thereby providing a second leached solid material and a second liquid phase;
wherein the first oxidiser and the second oxidiser are different.

### Oxidisers

The oxidisers of the present invention may oxidise one or more metals in the solid material to an oxidised form, resulting in the dissolution of the metal in the DES. Accordingly, the oxidisers of the present invention are an additional component to the components that form the DES (which are described below) and the oxidisers do not form part of the DES per se. The oxidiser may be added to a leaching solution after the DES has formed from the quaternary ammonium salt and a hydrogen bond donor.

In the first aspect of the present invention, the first and second oxidisers are not particularly limited except in that they are different. The ability of an oxidiser to oxidise and/or dissolve a given metal may depend on the reduction potential of the oxidiser. Therefore, the first and the second oxidiser of the present invention may have different reduction potentials. For example, the reduction potential of the second oxidiser may be more positive than the reduction potential of the first oxidiser. The first oxidiser, having a less positive reduction potential, may not be able to oxidise (and therefore dissolve) certain metals. This allows for the selective dissolution of certain metals in each step of the process. For example, the first oxidiser may be an oxidiser that cannot or does not oxidise gold, while the second oxidiser may be an oxidiser that oxidises gold.

The reduction potential of the first oxidiser may be less than or equal to +0.50 V, optionally from −1.00 V to +0.50 V, optionally from 0 V to +0.50 V, optionally from 0 V to +0.49 V for example, 0 V, +0.1 V, +0.2 V, +0.3 V, 0.4 V, or +0.49 V. An oxidiser having a reduction potential in these ranges may not be able to oxidise (and therefore dissolve) certain metals, including gold. The reduction potential of the second oxidiser may be greater than or equal to +0.50 V, optionally from +0.50 V to +2.0 V, optionally from +0.51 V to +2.0V, optionally from +1.0 V to +2.0 V, for example, +1.0 V, +1.1 V, +1.2 V, +1.3 V, +1.4 V, +1.5 V, +1.6 V, +1.7 V, +1.8 V, +1.9 V or +2.0 V. An oxidiser having a reduction potential in these ranges may be able to oxidise (and therefore dissolve) certain metals, including gold.

The first oxidiser may be an Fe(III) salt, a Cu(II) salt, a Te(IV) salt, a Cr(III) salt, or a Mn(VII) salt, preferably wherein the first oxidiser is an Fe(III) salt or a Cu(II) salt, more preferably wherein the first oxidiser is an Fe(III) salt. The first oxidiser may preferably be FeCl₃, FeF₃, FeBr₃, FeI₃, Fe(CN)₆, Fe(SCN)₃, Fe(NO₃)₃, Fe(SO₄)₃, Fe(OH)₃, Fe(C₂H₃O₂)₃, CuCl₂, CuF₂, CuBr₂, CuI₂, Cu(NO₃)₂, CuSO₄, CuO, Cu(OH)₂, TeCl₄, TeF₄, TeBr₄, TeI₄, TeO₂, or KMnO₄, more preferably wherein the first oxidiser is FeCl₃ or CuCl₂, even more preferably wherein the first oxidiser is FeCl₃. These oxidisers may not be able to oxidise (and therefore dissolve) certain metals, including gold.

The first oxidiser of the present invention may be present at a concentration of 0.001 mol dm⁻³ to 2.5 mol dm⁻³, preferably 0.01 mol dm⁻³ to 2 mol dm⁻³, more preferably 0.1 mol dm⁻³ to 1.5 mol dm⁻³, for example, 0.1 mol dm⁻³, 0.25 mol dm⁻³, 0.5 mol dm⁻³, 0.75 mol dm⁻³, 1 mol dm⁻³, 1.25 mol dm⁻³, or 1.5 mol dm⁻³.

The second oxidiser may be I₂ or SeCl₄, SeF₄, SeBr₄, SeI₄, SeO₂, preferably wherein the second oxidiser is iodine (I₂). These oxidisers may be able to oxidise (and therefore dissolve) certain metals, including gold. When iodine is the second oxidiser, a further benefit of the two-stage process is that less of the DES and iodine composition (which is more expensive) is required compared to a process in which only the DES and iodine composition is used to extract the metals due to there being less overall metal to leach after the first stage. Recovery of gold from the DES in the second stage may also be greatly simplified as fewer or no other metals are contained in the DES at this stage. As gold recovery is an important economic driver for the extraction of metals, this is an important benefit of the process.

The second oxidiser of the present invention may be present at a concentration of 0.001 mol dm⁻³ to 2.5 mol dm⁻³, preferably 0.01 mol dm⁻³ to 2 mol dm⁻³, more preferably 0.1 mol dm⁻³ to 1.5 mol dm⁻³, for example, 0.1 mol dm⁻³, 0.25 mol dm⁻³, 0.5 mol dm⁻³, 0.75 mol dm⁻³, 1 mol dm⁻³, 1.25 mol dm⁻³, or 1.5 mol dm⁻³.

### Deep Eutectic Solvents

The deep eutectic solvents of the present invention are prepared by reacting, or combining, or complexing a quaternary ammonium salt and a hydrogen bond donor.

In the first aspect of the present invention, the first and second quaternary ammonium salts are not particularly limited and may be any that are capable of forming a DES with the hydrogen bond donors described below. The first and second quaternary ammonium salts may each independently be a compound of Formula (I):

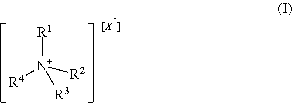

wherein R¹, R², R³, and R⁴ are each independently: H; a substituted or unsubstituted C₁-C₅ alkyl group; a substituted or unsubstituted C₆-C₁₀ cycloalkyl group; a substituted or unsubstituted C₆-C₁₂ aryl group; a substituted or unsubstituted C₇-C₁₂ alkaryl group; or,
wherein R¹ and R², taken together with the N atom to which they are attached, form a substituted or unsubstituted 5 to 11-membered ring, and R³ and R⁴ are as defined earlier;
wherein X⁻ is NO₃⁻, F⁻, Cl⁻, Br⁻, I⁻, BF₄⁻, ClO₄⁻, SO₃CF₃, bitartrate, dihydrogen citrate, or COOCF₃⁻, and,
wherein substituted means that the group may be substituted with one or more of the groups selected from: OH, SH, SR⁵, Cl, Br, F, I, NH₂, CN, NO₂, COO⁻, COOR⁵, CHO, COR⁵, and OR⁵, wherein R⁵ is H, a C₁-C₁₀ alkyl or a C₁-C₁₀ cycloalkyl group.

The first and second quaternary ammonium salts may each independently be a compound of Formula (I), wherein R¹, R² and R³ are each independently: H, or an unsubstituted C₁-C₄ alkyl group and R⁴ is a substituted or unsubstituted C₁-C₄ alkyl group and wherein the definitions of X⁻ and “substituted” are as above. More preferably wherein R¹, R² and R³ are each independently: H, or an unsubstituted C₁ alkyl group and R⁴ is a substituted or unsubstituted C₁-C₄ alkyl group, wherein substituted means that the group may be substituted with one or more of the groups selected from: OR⁵, COO⁻, and COOR⁵, wherein R⁵ is H, a C₁-C₁₀ alkyl or a C₁-C₁₀ cycloalkyl group and wherein X⁻ is as defined above.

For example, the first and second quaternary ammonium salts may each independently be choline chloride, choline hydroxide, choline acetate, choline bitartrate, choline dihydrogencitrate, betaine, betaine HCl, ammonium chloride, methylammonium chloride, ethylammonium chloride, tetra-butylammonium chloride, or ethanolamine hydrochloride, preferably wherein the first and second quaternary ammonium salts are choline chloride.

The first and second hydrogen bond donors of the present invention are not particularly limited and may be any that are capable of forming a DES with the quaternary ammonium salts described above. The first and second hydrogen bond donors may each independently be a compound of the formula R⁶COOH, R⁷R⁸NH, R⁹CZNH₂, R¹⁰OH, or HO—R¹¹—OH wherein:
R⁶, R⁷, R⁸, and R¹⁰ are each independently H; a substituted or unsubstituted C₁-C₈ alkyl group; a substituted or unsubstituted C₁-C₈ alkenyl group, a substituted or unsubstituted aryl group; or, a substituted or unsubstituted C₇-C₁₂ alkaryl group; and R¹¹ is a substituted or unsubstituted C₁-C₁₁ alkyl group;
wherein substituted means substituted with one or more groups selected from OH, SR₅, Cl, Br, F, I, NH₂, CN, NO₂, 3,4-dihydroxy-2H-furan-5-one, CONR⁵, COOR⁵, COR⁵ and OR⁵, wherein R⁵ is H, a C₁ to C₁₀ alkyl or a C₁-C₁₀ cycloalkyl group;
R⁹ is a group as defined for R⁶, or NHR¹² wherein R¹² is H or a C₁-C₆ alkyl group; and, Z is O or S

The first and second hydrogen bond donors may each independently be a compound of the formula R⁶COOH, R⁹CZNH₂, or HO—R¹¹—OH, wherein R⁶, R⁹, Z and R¹¹ are as defined above.

The first and second hydrogen bond donors may each independently be a compound of the formula R⁶COOH, R⁹CZNH₂, or HO—R¹¹—OH, wherein
R⁶ is a substituted or unsubstituted C₁-C₆ alkyl group; a substituted or unsubstituted C₁-C₆ alkenyl group, or a substituted or unsubstituted aryl group;
R⁹ is a substituted or unsubstituted C₁-C₆ alkyl group or a substituted or unsubstituted C₁-C₆ alkenyl group or NHR¹² wherein R¹² is H or a substituted or unsubstituted C₁-C₆ alkyl group; and, Z is O; and
R¹¹ is a substituted or unsubstituted C₁-C₈ alkyl group;
wherein substituted means substituted with one or more groups selected from OH, CONR⁵, COOR⁵, COR⁵ and OR⁵, wherein R⁵ is H, a C, to C₆ alkyl or a C₁-C₆ cycloalkyl group.

The first and second hydrogen bond donors may each independently be a compound of the formula R⁶COOH, R⁹CZNH₂, or HO—R¹¹—OH, wherein
R⁶ is a substituted or unsubstituted C₁-C₅ alkyl group; a substituted or unsubstituted C₁-C₄ alkenyl group, or a substituted or unsubstituted aryl group;
R⁹ is a substituted or unsubstituted C₁-C₅ alkyl group or a substituted or unsubstituted C₁-C₄ alkenyl group or NHR¹² wherein R¹² is H or a C₁-C₆ alkyl group; and, Z is O; and
R¹¹ is a substituted or unsubstituted C₁-C₅ alkyl group;
wherein substituted means substituted with one or more groups selected from OH, CONR⁵, COOR⁵, COR⁵ and OR⁵, wherein R⁵ is H, or a C₁ to C₆ alkyl group.

The first and second hydrogen bond donors may each independently be a compound of the formula R⁶COOH, or HO—R¹¹—OH, wherein
R⁶ is a substituted or unsubstituted C₁-C₅ alkyl group; a substituted or unsubstituted C₁-C₄ alkenyl group, or a substituted or unsubstituted aryl group;
R¹¹ is a substituted or unsubstituted C₁-C₅ alkyl group;
   wherein substituted means substituted with one or more groups selected from OH, CONR⁵, and COOR⁵, wherein R⁵ is H, or a C₁ alkyl group.

The first and second hydrogen bond donors may each independently be a compound of the formula HO—R¹¹—OH, wherein
R¹¹ is a C₁-C₅ alkyl group, which may be substituted with one or more groups selected from OH and COOR⁵, wherein R⁵ is H, or a C₁ alkyl group.

For example, the first and second hydrogen bond donors may each independently be ethylene glycol, glycerol, 1,2-propanediol, 1,3-propandiol, 1,4-butandiol, 1,5-pentandiol, urea, oxalic acid, malonic acid, levulinic acid, lactic acid, citric acid, maleic acid, malonamide, acetamide, oxalic acid dihydrate, ascorbic acid, glutaric acid, glycolic acid, mandelic acid, succinic acid, tartaric acid or phenol, preferably wherein the first and second hydrogen bond donors are ethylene glycol.

The molar ratio of first quaternary ammonium salt to the first hydrogen bond donor is not particularly limited except that it must be a ratio that results in the formation of a DES when the first quaternary ammonium salt and the first hydrogen bond donor are combined. The molar ratio of first quaternary ammonium salt to the first hydrogen bond donor may be from 4:1 to 1:20, preferably 3.5:1 to 1:15, more preferably 2.5:1 to 1:10, more preferably 2:1 to 1:4, for example, 2:1, 1:1, 1:2, 1:3, or 1:4.

The molar ratio of the second quaternary ammonium salt to the second hydrogen bond donor is not particularly limited except that must be a ratio that results in the formation of a DES when the second quaternary ammonium salt to the second hydrogen bond donor are combined. The molar ratio of second quaternary ammonium salt to the second hydrogen bond donor may be from 4:1 to 1:20, preferably 3.5:1 to 1:15, more preferably 2.5:1 to 1:10, more preferably 2:1 to 1:4, for example, 2:1, 1:1, 1:2, 1:3, or 1:4.

The present inventors have discovered that a DES comprising choline chloride and ethylene glycol in a 1:2 stoichiometric ratio (known in the art as E200) is advantageous for carrying out the steps of the present invention.

The DES can be diluted with aqueous and/or organic solvents ranging from 0% diluent to a maximum 75% diluent (w/w). The diluent may be one or more selected from the group consisting of water, ethanol, acetonitrile, dichloromethane, or acetone. A DES may be hygroscopic and may contain a certain amount of water inherently, for example 2% (w/w). The DES may be further diluted with water to a total water weight of, for example, 16% (w/w).

### Process Parameters

The solid material may be any solid material that comprises metals. The solid material may be solid waste material such as electronic waste material, for example printed circuit boards. The metals in the solid material are not particularly limited and may be any metal known to the skilled person. For example, the metals may comprise one or more selected from the group consisting of aluminium, steel, copper, nickel, tin, lead, palladium, zinc, silver, chromium, cobalt, vanadium, indium, mercury, antimony, gallium, beryllium, molybdenum, cadmium, and gold.

The first liquid phase may comprise any or all of the above metals, or the first liquid phase may comprise any or all of the above metals except for gold. The second liquid phase may comprise any or all of the above metals, or the second liquid phase may only comprise gold.

Prior to performing the leaching steps, the solid material may be comminuted by crushing, grinding, or shredding to reduce its particle size. This may improve the efficiency of the leaching processes by reducing the amount of DES and oxidiser that is required to extract the metals. The solid material may be comminuted to a particle size of less than 10 mm, preferably less than 1.2 mm, for example 10 microns to 1 mm. In an embodiment, the solid material is comminuted and separated into two fractions using a sieve having a pore size of 1.2 mm before DES treatment. Additionally, aluminium and steel may be removed prior to performing the leaching steps by, for example, gravimetric/eddy current/magnetic separation techniques. This may also improve the efficiency of the leaching processes.

In the first and second leaching steps, the ratio of DES plus the oxidiser to metal in the solid material may be from 1:50 to 100:1 (w:w), 1:40 to 75:1, 1:30 to 50:1, 1:25 to 25:1, or 1:20 to 10:1, for example 1:20, 1:15, 1:10, 1:5, 1:1, 5:1, or 10:1 (w:w).

In the first and second leaching steps, the ratio of DES to solid material may be from 1:50 to 100:1 (v/w), from 1:10 to 50:1, from 1:5 to 40:1, from 1:1 to 30:1, from 2:1 to 25:1, for example, 2:1, 3:1, 4:1, 5:1, 10:1, 15:1, 20:1 or 25:1 (v/w).

In the first and second leaching steps, the solid material may be leached at a temperature of 10° C. to 120° C., optionally 40° C. to 110° C., optionally 50° C. to 100° C., for example, 50, 55, 60, 65, 70, 75, 80, 85, 90, 95 or 100° C. In the first and second leaching steps, the solid material may be leached for 5 minutes to 240 hours, preferably 1 hour to 144 hours, more preferably 6 hours to 96 hours, more preferably 12 hours to 48 hours, more preferably 18 hours to 36 hours, for example, 18, 24, 30 or 36 hours. In an embodiment, the solid material is leached at a temperature of 10° C. to 120° C. for 5 minutes to 240 hours, preferably at 80° C. for 24 hours.

In a particular embodiment of the first aspect of the present invention, the first and second quaternary ammonium salts may each independently be choline chloride, choline hydroxide, choline acetate, choline bitartrate, choline dihydrogencitrate, betaine, betaine HCl, ammonium chloride, methylammonium chloride, ethylammonium chloride, tetra-butylammonium chloride, or ethanolamine hydrochloride; preferably wherein the first and second quaternary ammonium salts are choline chloride;
the first and second hydrogen bond donors may each independently be ethylene glycol, glycerol, 1,2-propanediol, 1,3-propandiol, 1,4-butandiol, 1,5-pentandiol, urea, oxalic acid, malonic acid, levulinic acid, lactic acid, citric acid, maleic acid, malonamide urea, acetamide, oxalic acid dihydrate, ascorbic acid, glutaric acid, glycolic acid, mandelic acid, succinic acid, tartaric acid or phenol, preferably wherein the first and second hydrogen bond donors are ethylene glycol;
the molar ratios of the first and second quaternary ammonium salts to the first and second hydrogen bond donors may be from 4:1 to 1:20, preferably 2:1 to 1:4;
the reduction potential of the first oxidiser may be less than or equal to +0.50 V and/or the first oxidiser may be an Fe(III) salt, a Cu(II) salt, a Te(IV) salt, a Cr(III) salt, or a Mn(VII) salt, preferably wherein the first oxidiser is an Fe(III) salt or a Cu(II) salt, preferably FeCl₃ or CuCl₂, more preferably wherein the first oxidiser is FeCl₃; and,
the reduction potential of the second oxidiser may be greater than or equal to +0.50 V and/or the second oxidiser may be I₂ or SeCl₄, SeF₄, SeBr₄, SeI₄, SeO₂, preferably wherein the second oxidiser is I₂.

In a particular embodiment of the first aspect of the present invention the first and second quaternary ammonium salts are choline chloride; the first and second hydrogen bond donors are ethylene glycol; the molar ratios of the first quaternary ammonium salt to the first hydrogen bond donor and the second quaternary ammonium salt to the second hydrogen bond donor are both 1:2; the reduction potential of the first oxidiser is less than or equal to +0.50 V and/or the first oxidiser is an Fe(III) salt, or a Cu(II) salt, preferably FeCl₃ or CuCl₂; and, the reduction potential of the second oxidiser is greater than or equal to +0.50 V and/or the second oxidiser is I₂.

The processes of the present invention may further comprise a step of recovering one or more metals from the first liquid phase; and/or recovering one or more metals from the second liquid phase. The processes for recovering metals from solution according to the present invention are not particularly limited and may be any of those known to the skilled person. Metals may be recovered individually or together with other metals. The recovery processes may include solvent extraction, precipitation (for example cementation), and/or processes whereby the metals are recovered from solution by means of electrolytic chemical reaction (for example electrowinning). In a particular embodiment, gold is recovered by the addition of activated carbon (e.g. Jacobi PICAGOLD® G210AS).

During the leaching steps, the oxidisers oxidise the metals in the solid material, which may cause the oxidiser to be reduced such that it is no longer able to oxidise. Accordingly, the processes of the present invention may further comprise a step of regenerating the oxidisers. The step of regenerating may be performed after a leaching step or it may be performed simultaneously with the leaching step so that the oxidiser is regenerated in situ. The oxidisers may be regenerated by any means known to the skilled person. For example, the oxidiser may be regenerated by bubbling oxygen into a leaching solution or a liquid phase that results from a leaching step. This method may be particularly advantageous if the oxidiser is an Fe(III) salt, a Cu(II) salt, a Te(IV) salt, a Cr(III) salt, or a Mn(VII) salt, for example if the oxidiser is FeCl₃. The oxidisers may be regenerated by means of electrolytic chemical reaction, for example, by inserting electrodes into a leaching solution or a liquid phase that results from a leaching step and applying a voltage.

The processes of the present invention may further comprise steps of filtering, and/or cleaning and/or drying the solid material after each of the leaching steps. These additional steps may improve the efficiency of any subsequent leaching steps.

When viewed from a second aspect, the present invention provides a process for the extraction of one or more metals from a solid material, the process comprising:
(i) a leaching step comprising contacting the solid material with a leaching solution comprising:
a deep eutectic solvent (DES) formed by the reaction of a quaternary ammonium salt and a hydrogen bond donor in a molar ratio of from 4:1 to 1:20; and,
a first oxidiser;
wherein the reduction potential of the first oxidiser is less than or equal to +0.50V and/or wherein the first oxidiser is an Fe(III) salt, a Cu(II) salt, a Te(IV) salt, a Cr(III) salt, or a Mn(VII) salt.

When viewed from a third aspect, the present invention provides a composition for leaching one or more metals from a solid material comprising:
a deep eutectic solvent formed by the reaction of a first quaternary ammonium salt and a first hydrogen bond donor in a molar ratio of 4:1 to 1:20; and
a first oxidiser;
wherein the reduction potential of the first oxidiser is less than or equal to +0.50V and/or wherein the first oxidiser is an Fe(III) salt, a Cu(II) salt, a Te(IV) salt, a Cr(III) salt, or a Mn(VII) salt.

The description of the features of the first aspect (including the description of the first oxidiser, the Deep Eutectic Solvents and the process parameters) can be equally applied to the second and third aspects of the present invention.

In the above regard, the reduction potential of the first oxidiser may be less than or equal to +0.50 V, optionally from −1.00 V to +0.50 V, optionally from 0 V to +0.50 V, for example, 0 V, +0.1 V, +0.2 V, +0.3 V, +0.4 V, or +0.5 V, optionally from 0 V to +0.49 V. An oxidiser having a reduction potential in these ranges may not be able to oxidise (and therefore dissolve) certain metals, including gold. The reduction potential of the second oxidiser may be greater than or equal to +0.50 V, optionally from +0.50 V to +2.0 V, optionally from +0.51 V to +2.0 V optionally from +1.0 V to +2.0 V, for example, +1.0 V, +1.1 V, +1.2 V, +1.3 V, +1.4 V, +1.5 V, +1.6 V, +1.7 V, +1.8 V, +1.9 V or +2.0 V. An oxidiser having a reduction potential in these ranges may be able to oxidise (and therefore dissolve) certain metals, including gold.

The first oxidiser may be an Fe(III) salt, a Cu(II) salt, a Te(IV) salt, a Cr(III) salt, or a Mn(VII) salt, preferably an Fe(III) salt or a Cu(II) salt, more preferably an Fe(III) salt. The first oxidiser may preferably be FeCl₃, FeF₃, FeBr₃, FeI₃, Fe(CN)₆, Fe(SCN)₃, Fe(NO₃)₃, Fe(SO₄)₃, Fe(OH)₃, Fe(C₂H₃O₂)₃, CuCl₂, CuF₂, CuBr₂, CuI₂, Cu(NO₃)₂, CuSO₄, CuO, Cu(OH)₂, TeCl₄, TeF₄, TeBr₄, TeI₄, TeO₂, or KMnO₄, more preferably wherein the first oxidiser is FeCl₃ or CuCl₂, even more preferably wherein the first oxidiser is FeCl₃. These oxidisers may not be able to oxidise (and therefore dissolve) certain metals, including gold.

The first oxidiser of the present invention may be present at a concentration of 0.001 mol dm⁻³ to 2.5 mol dm⁻³, preferably 0.01 mol dm⁻³ to 2 mol dm⁻³, more preferably 0.1 mol dm⁻³ to 1.5 mol dm⁻³, for example, 0.1 mol dm⁻³, 0.25 mol dm⁻³, 0.5 mol dm⁻³, 0.75 mol dm⁻³, 1 mol dm⁻³, 1.25 mol dm⁻³, or 1.5 mol dm⁻³.

### EXAMPLES

### Reduction Potentials

The reduction potentials of oxidisers recited in the present application were measured as a formal reduction potential in the respective DES using an Ag reference electrode in AgCl (0.1 M).

### Leaching Efficiencies

Leaching efficiencies (i.e. the percentage of each metal that is recovered during a leaching stage) were determined by leaching the solid material remaining following the leaching step in aqua regia for 24 hours to dissolve all remaining metal. The concentration of the metals in the aqua regia was determined via Inductively Coupled Plasma Mass Spectrometry (ICP-MS).

### Example 1—Metal Dissolution with DES+FeCl₃ and DES+I₂

The purpose of the study was to determine whether Au would be dissolved in DES+FeCl₃ or DES+I₂ when in close proximity to Cu and Ni, which are other metals commonly found in E-waste.

The DES was formed by combining choline chloride and ethylene glycol in a 1:2 stoichiometric ratio with heating at 50° C. and stirring until a clear homogenous liquid formed. This DES is known in the art as E200. To form E200+1M FeCl₃, FeCl₃ was added to E200 (1 L) to an FeCl₃ concentration of 1M with stirring at 50° C. until all solid had dissolved. To form E200+0.5M I₂, I₂ was added to E200 (1 L) to an I₂ concentration of 0.5M with stirring at 50° C. until all solid had dissolved.

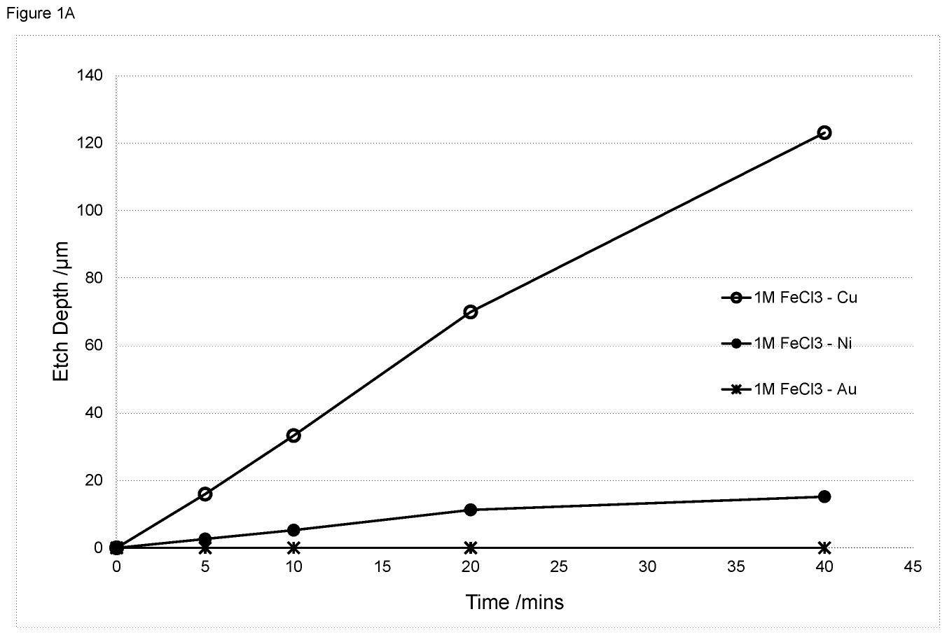

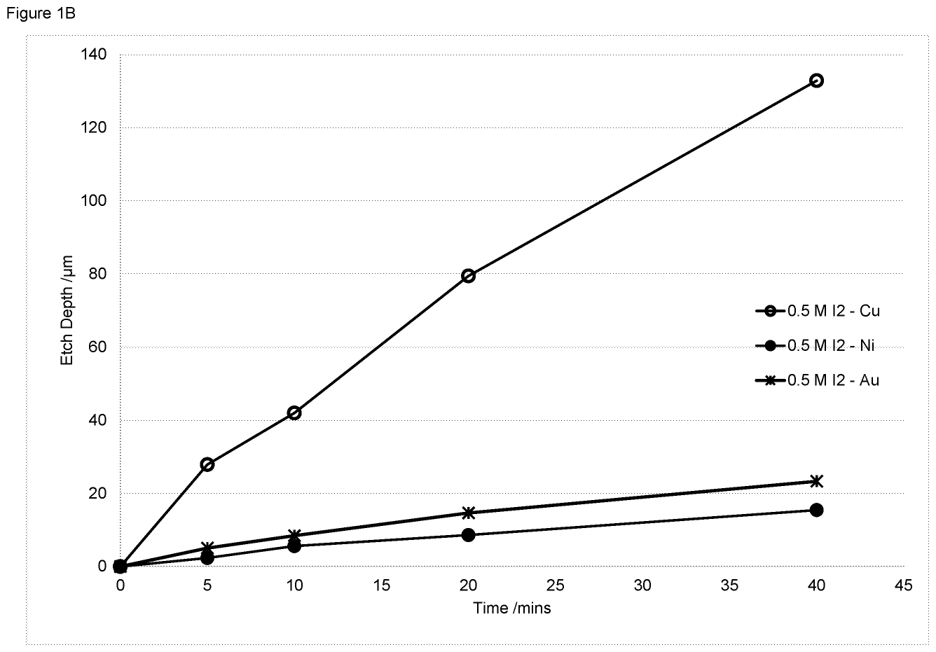

Polished resin blocks made from Araldite 2020 Resin (E), were supplied by RS Components Pty Ltd containing adjacent deposits of Cu, Ni and Au metals approximately 1 mm thick. A resin block was submerged in 200 mL of E200+1M FeCl₃ prepared as above for 40 minutes at 50° C. and a separate resin block was submerged in 200 mL of E200+0.5M I₂ prepared as above for 40 minutes at 50° C. At time intervals of 0, 5, 10, 20 and 40 minutes the blocks were removed, washed with deionised water and washed with acetone. A Zeta™ Instruments Zeta 2000 optical profiler using the inbuilt Zeta3D software version 1.8.5 was used to measure the etch depth of the Cu, Ni and Au before, at these time intervals. In this regard, a baseline was created by measuring the height of the metals against the resin before treatment with the DES formulations. The metal height was measured during and after the treatment and the etch depth was determined by calculating the difference between the measured height and the baseline. The results are shown in Table 1 below and FIGS. 1A and 1B.

TABLE 1

| | | | Time/mins | | | | |
|---|---|---|---|---|---|---|---|
| DES | Metal | | 0 | 5 | 10 | 20 | 40 |
| E200 + 1M FeCl₃ | Cu | Etch | 0.00 | 15.92 | 33.26 | 69.89 | 123.03 |
| E200 + 1M FeCl₃ | Ni | Depth/ | 0.00 | 2.62 | 5.23 | 11.24 | 15.17 |
| E200 + 1M FeCl₃ | Au | μm | 0.00 | 0.00 | 0.00 | 0.00 | 0.00 |
| E200 + 0.5M I₂ | Cu | | 0.00 | 27.87 | 41.97 | 79.46 | 132.87 |
| E200 + 0.5M I₂ | Ni | | 0.00 | 2.32 | 5.57 | 8.59 | 15.43 |
| E200 + 0.5M I₂ | Au | | 0.00 | 5.04 | 8.42 | 14.63 | 23.31 |

As shown by Table 1 and FIGS. 1A and 1B, Cu and Ni dissolved using both DES formulations. Au was dissolved when using I₂ as the oxidiser in E200, but Au was not dissolved when using FeCl₃ as the oxidiser in E200.

### Example 2—Two-Stage Leaching Process Performed on Comminuted e-Waste

E-waste comprising a mixture of commercially-available PCBs, CPUs, RAM sticks, connectors and other high grade E-waste materials was investigated for bulk dissolution using the two-stage DES leaching process of the present invention.

The E-waste was supplied by PMS Handelskontor GmbH having been comminuted and processed using their VeRoLiberator® technology. The material as supplied was sieved through a 1.2 mm pore sieve and separated into a <1.2 mm and a ≥1.2 mm fraction. A NdFeB supermagnet wrapped in a plastic sheathe was passed over both fractions to remove ferrous material. A typical distribution of metals for each sized fraction prior to ferrous material removal can be seen in Table 2:

TABLE 2
Assay data of different fractions sizes of comminuted E-waste.

| | Element | | | | | | | | | | |
|---|---|---|---|---|---|---|---|---|---|---|---|
| | Cu | Ni | Co | Pd | Au | Ag | Pb | Sn | Fe | Al | Ca |
| Fraction | % | % | % | g/ton | g/ton | g/ton | ppm | ppm | % | % | % |
| <1.2 mm | 21.5 | 0.6 | 0.014 | 14.1 | 221 | 1459 | 8377 | 46815 | 7.3 | 3.9 | 2.6 |
| ≥1.2 mm | 20.4 | 0.5 | 0.014 | 1.3 | 17 | 201 | 2157 | 15845 | 12.9 | 4.1 | 1.6 |

The fractions were split into 50.0 g batches and combined with a preheated DES1 formulation in the DES:solid ratios set out in Table 3 and stirred on a hotplate stirrer using a magnetic stirrer bar for 24 hours at 80° C. The DES1 formulations were prepared as in Example 1 above. During this 24 hour period, aliquots of 5.0 mL were taken and analysed by Inductively Coupled Plasma Mass Spetrometry (ICP-MS). The ICP-MS used was a Thermo Scientific™ iCAP™q-c Quadrupole ICP-MS, with a Cetac™ ASX520 Autosampler using Qtegra™ software version 2.10.3324.131.

The resulting solids were vacuum filtered, washed in hot deionised water until all DES1 had been removed from the solid and then dried in a vacuum oven for 24 hours at 50° C. This dried material was then transferred to the preheated DES2 formulation in the DES2:solid ratio described in Table 3 and stirred on a hotplate stirrer using a magnetic stirrer bar for 24 hours at 80° C. The DES2 formulations were prepared as in Example 1 above. The resulting solids were vacuum filtered and washed using ethanol and then hot deionised water until all DES2 had been removed from the solid and then dried in a vacuum oven for 24 hours at 50° C. Due to the heterogeneous nature of the E-waste materials, total dissolution of metals were calculated by dissolving the remaining solid residue in aqua regia for 24 hours in a liquid to solid ratio of 5:1 at room temperature and analysed using ICP-MS. The percentage leached values recited in Tables 4-7 were calculated by calibrating the metal concentration at each time interval (as measured by ICP-MS) against the starting concentration and the concentration in the aqua regia solution (both measured by ICP-MS).

TABLE 3
Experiment description testing different DES1 formulations at
different DES:solid ratios and different E-waste fractions.

| | | | DES1 | | DES2 | |
|---|---|---|---|---|---|---|
| Exper- | E-Waste | | Formu- | DES1:Solid | Formu- | DES2:Solid |
| iment | Fraction | | lation | Ratio v/w | lation | Ratio v/w |
| EW001 | <1.2 | mm | E200 + | 15:1 | E200 + | 3:1 |
| | | | 1M FeCl₃ | | 0.5M I₂ | |
| EW002 | <1.2 | mm | E200 + | 20:1 | E200 + | 5:1 |
| | | | 1M FeCl₃ | | 0.5M I₂ | |
| EW003 | <1.2 | mm | E200 + | 20:1 | E200 + | 5:1 |
| | | | 1M CuCl₂ | | 0.5M I₂ | |
| EW004 | ≥1.2 | mm | E200 + | 20:1 | E200 + | 5:1 |
| | | | 1M CuCl₂ | | 0.5M I₂ | |

The percentage of Al, Ni, Cu, Ag, Sn, Au and Pb leached during EW001-EW004 is shown in Tables 4-7 below respectively.

TABLE 4
Leaching data from EW001

| | Total | DES1/% Leached | | | | | DES2/% Leached | | | | |
|---|---|---|---|---|---|---|---|---|---|---|---|
| | Time/hr | 0.5 | 1 | 3 | 6 | 24 | 24.5 | 25 | 27 | 30 | 48 |
| Element | Al | 79.3 | 82.2 | 83.5 | 78.3 | 85.3 | 0.0 | 0.0 | 0.1 | 0.5 | 0.8 |
| | Ni | 41.1 | 55.9 | 90.3 | 91.1 | 98.9 | 0.2 | 0.2 | 0.3 | 0.3 | 0.4 |
| | Cu | 39.5 | 61.0 | 91.8 | 92.2 | 99.6 | 0.2 | 0.2 | 0.2 | 0.2 | 0.3 |
| | Ag | 46.9 | 86.3 | 123.8 | 110.1 | 98.8 | 0.1 | 0.3 | 0.2 | 0.2 | 0.1 |
| | Sn | 56.8 | 75.0 | 92.0 | 87.7 | 91.4 | 0.2 | 0.4 | 1.4 | 6.4 | 6.3 |
| | Au | 1.1 | 1.1 | 1.1 | 1.1 | 1.1 | 63.9 | 64.2 | 68.0 | 87.2 | 99.2 |
| | Pb | 38.9 | 57.8 | 96.7 | 90.7 | 98.1 | 0.9 | 1.0 | 1.2 | 1.4 | 1.4 |

TABLE 5
Leaching data from EW002

| | Total | DES1/% Leached | | | | | | | DES2/% Leached | | | | | | |
|---|---|---|---|---|---|---|---|---|---|---|---|---|---|---|---|
| | Time/hr | 0.5 | 1 | 2 | 4 | 5 | 6 | 24 | 24.5 | 25 | 26 | 28 | 29 | 30 | 48 |
| Element | Al | 7.6 | 16.0 | 50.6 | 63.6 | 64.4 | 62.0 | 74.5 | 0.5 | 0.7 | 0.9 | 2.7 | 5.0 | 4.5 | 5.8 |
| | Ni | 65.7 | 77.6 | 86.0 | 85.0 | 86.3 | 82.1 | 98.3 | 0.2 | 0.3 | 0.4 | 0.4 | 0.4 | 0.5 | 0.6 |
| | Cu | 60.0 | 75.1 | 87.1 | 86.0 | 87.0 | 82.3 | 99.6 | 0.2 | 0.3 | 0.3 | 0.3 | 0.3 | 0.3 | 0.4 |
| | Ag | 63.7 | 74.0 | 95.1 | 91.3 | 97.0 | 88.1 | 96.9 | 1.8 | 2.1 | 1.4 | 2.2 | 1.7 | 2.2 | 1.4 |
| | Sn | 55.6 | 72.8 | 86.9 | 86.0 | 87.6 | 83.5 | 99.0 | 0.1 | 0.1 | 0.2 | 0.4 | 0.5 | 0.5 | 0.7 |
| | Au | 1.5 | 2.2 | 2.4 | 2.3 | 2.5 | 2.3 | 3.8 | 25.5 | 28.7 | 35.0 | 40.0 | 38.6 | 33.5 | 93.5 |
| | Pb | 35.2 | 55.4 | 80.0 | 84.0 | 85.5 | 82.8 | 99.3 | 0.1 | 0.1 | 0.1 | 0.2 | 0.2 | 0.2 | 0.2 |

TABLE 6
Leaching data from EW003

| | Total | DES1/% Leached | | | | | | | DES2/% Leached | | | | |
|---|---|---|---|---|---|---|---|---|---|---|---|---|---|
| | Time/hr | 0.5 | 1 | 2 | 4 | 5 | 6 | 24 | 24.5 | 25 | 26 | 28 | 48 |
| Element | Al | 60.2 | 62.6 | 65.3 | 66.0 | 67.1 | 63.6 | 79.4 | 0.4 | 0.4 | 0.5 | 0.8 | 1.8 |
| | Ni | 48.7 | 52.7 | 55.2 | 57.1 | 58.0 | 55.8 | 69.9 | 0.3 | 0.3 | 0.4 | 0.7 | 2.3 |
| | Cu | 70.9 | 76.4 | 79.7 | 80.9 | 82.3 | 76.4 | 98.1 | 0.1 | 0.2 | 0.3 | 0.4 | 0.8 |
| | Ag | 62.2 | 67.3 | 67.0 | 61.5 | 80.2 | 74.0 | 96.5 | 2.9 | 2.1 | 2.6 | 2.2 | 2.4 |
| | Sn | 37.5 | 60.6 | 41.0 | 67.3 | 64.8 | 73.0 | 91.7 | 0.6 | 0.7 | 0.9 | 1.4 | 3.8 |
| | Au | 2.2 | 2.6 | 3.4 | 3.5 | 4.1 | 4.0 | 5.9 | 85.2 | 78.4 | 90.6 | 96.2 | 94.6 |
| | Pb | 56.4 | 72.5 | 80.0 | 82.1 | 83.4 | 81.5 | 99.0 | 0.4 | 0.4 | 0.5 | 0.5 | 0.6 |

TABLE 7
Leaching data from EW004

| | Total | DES1/% Leached | | | | | DES2/% Leached | | | | | | |
|---|---|---|---|---|---|---|---|---|---|---|---|---|---|
| | Time/hr | 1 | 2 | 4 | 5 | 24 | 24.5 | 25 | 26 | 28 | 29 | 30 | 48 |
| Element | Al | 97.0 | 96.2 | 96.9 | 97.0 | 92.6 | 0.0 | 0.1 | 0.1 | 0.2 | 0.3 | 0.1 | 0.2 |
| | Ni | 74.4 | 72.7 | 78.5 | 82.5 | 74.8 | 0.8 | 1.8 | 0.9 | 1.7 | 2.8 | 0.8 | 1.9 |
| | Cu | 80.8 | 88.1 | 96.7 | 100.8 | 99.7 | 0.0 | 0.0 | 0.0 | 0.0 | 0.0 | 0.0 | 0.1 |
| | Ag | 35.2 | 55.6 | 86.4 | 98.8 | 98.9 | 1.3 | 1.5 | 1.5 | 1.7 | 1.7 | 1.7 | 0.6 |
| | Sn | 54.6 | 72.8 | 87.9 | 91.3 | 91.2 | 0.2 | 0.8 | 0.5 | 1.8 | 2.2 | 0.4 | 2.0 |
| | Au | 1.7 | 1.8 | 2.1 | 1.9 | 2.6 | 41.6 | 39.5 | 30.8 | 29.6 | 27.0 | 76.6 | 92.2 |
| | Pb | 26.8 | 49.9 | 74.5 | 89.2 | 99.6 | 0.0 | 0.1 | 0.1 | 0.1 | 0.2 | 0.1 | 0.2 |

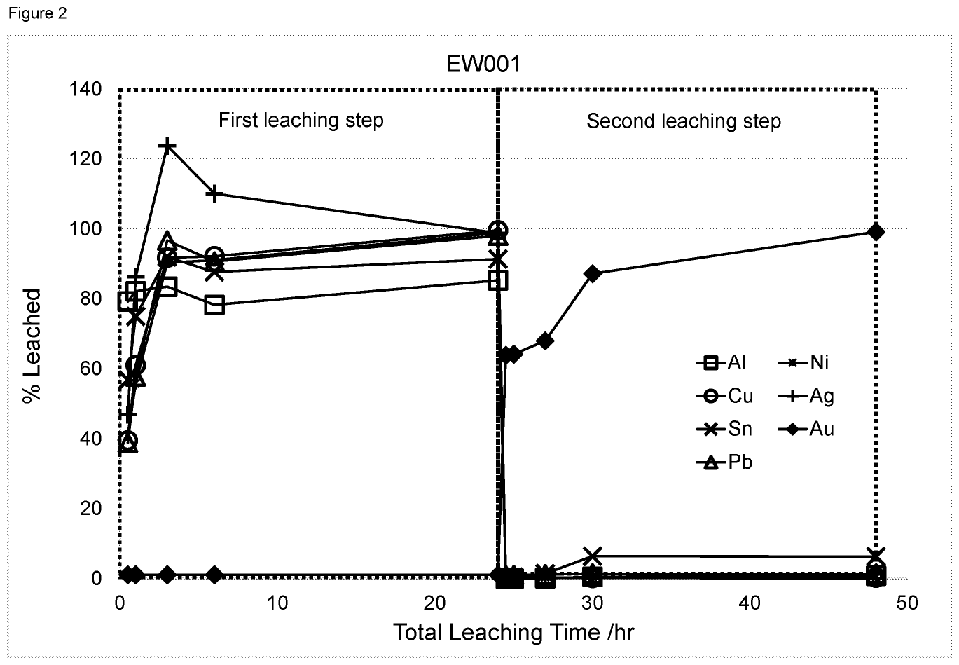

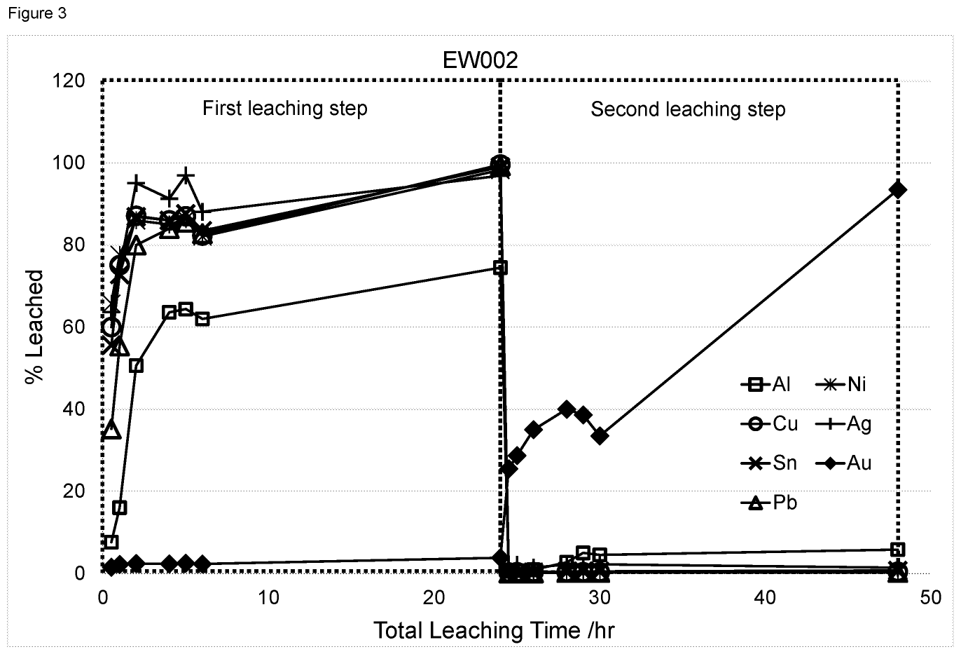

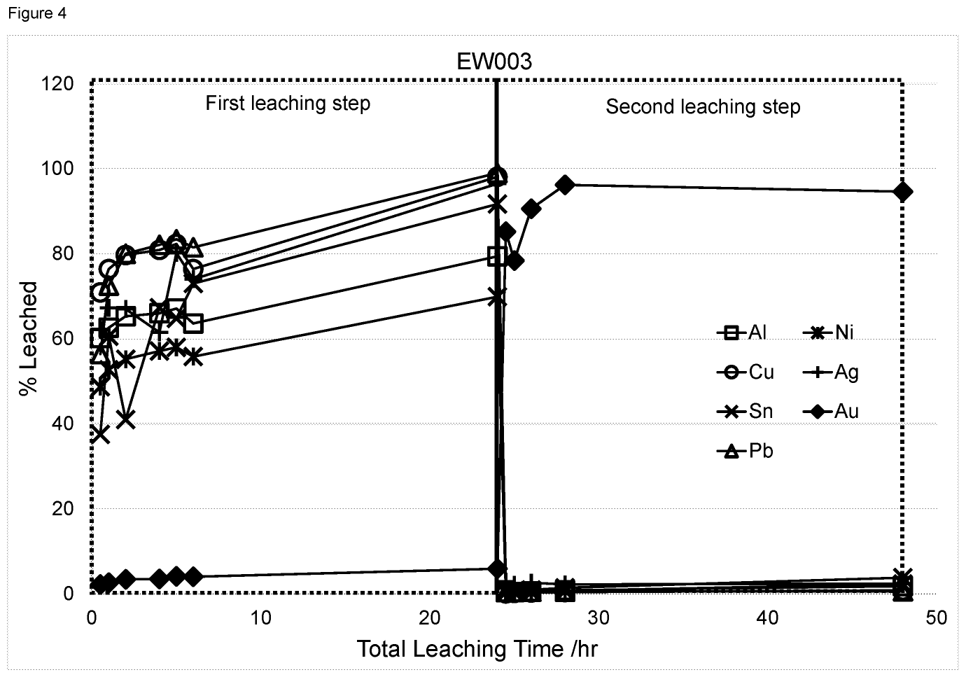

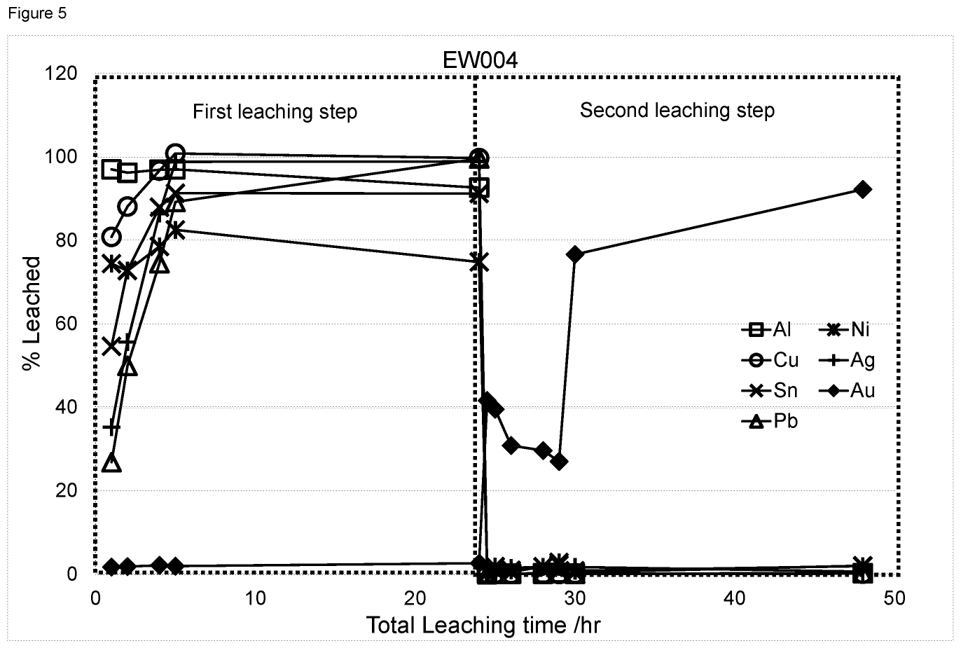

FIGS. 2-5 show the percentage of Al, Ni, Cu, Ag, Sn, Au and Pb leached during treatment with DES1 and DES2 in Experiments EW001, EW002, EW003 and EW004 respectively. As is clear from the Figures, treatment with DES1, in which a less positive oxidiser is present, leaches up to 100% of Al, Ni, Cu, Ag, Sn, and Pb and little or no Au, while treatment with DES2, in which a different, more positive oxidiser is present, over 90% of Au is leached.

### Example 3—the Effect of Different Oxidisers and Temperature

A series of mass loss experiments designed to investigate the total mass loss to the <1.2 mm E-waste fraction prepared as in Example 2 as a function of time and DES formulation were performed.

Table 8 shows data from 10 individual experiments that involved treating 10.00 g of the <1.2 mm E-waste fraction using the DES formulation recited in row 2 of columns 2-4 for the time recited in each row of column 1. Each timed experiment was run independently on 10.00 g of <1.2 mm E-waste material and the mass of remaining E-waste material was measured after vacuum filtration of the DES formulation, washing with deionised water and then subsequently drying under vacuum at 50° C. for 24 hours.

TABLE 8
Mass loss data for <1.2 mm E-waste using
different DES formulations and conditions.

| | Mass Loss/wt % | | |
|---|---|---|---|
| | E200 + 1M FeCl₃ | E200 + 1M CuCl₂ | E200 + 1M FeCl₃ |
| Time/hr | at 80° C. | at 80° C. | at 40° C. |
| 0.25 | 28.4 | 16.4 | 9.3 |
| 0.5 | 34.4 | 24.4 | 15.1 |
| 1 | 37.3 | 35.2 | 17.4 |
| 1.5 | 42.6 | 29.4 | 23.3 |
| 2 | 39.3 | 39.1 | 21.6 |
| 3 | 40.2 | 39.5 | 27.9 |
| 4 | 40.4 | 39.9 | 29.0 |
| 5 | 40.1 | 39.2 | — |
| 6 | 39.3 | 39.2 | 33.3 |
| 24 | 40.5 | 40.6 | 37.4 |

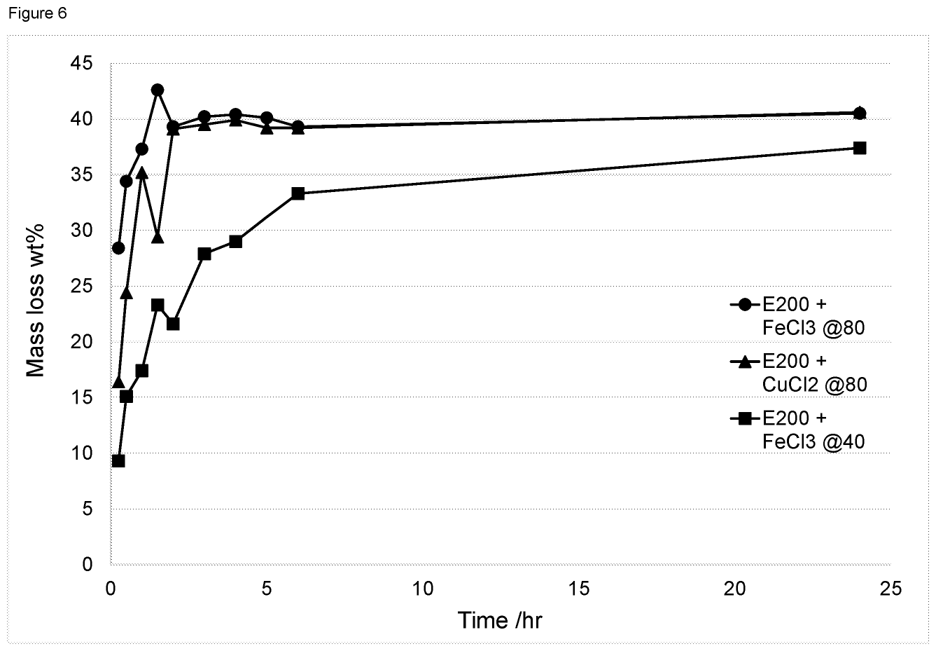

The data in Table 8 are shown graphically in FIG. 6. This Figure shows that a lower temperature results in a slower initial rate of mass loss, with a similar total mass loss after 24 hours. The rate and total mass loss is approximately the same when CuCl₂ and FeCl₃ are used as oxidisers at the same temperature.

### Example 4—Effect of Temperature, Water Content, DES:Solid Ratio and Time of DES1-E200+1M FeCl₃ on Leaching <1.2 mm E-Waste

The effect of temperature, water content, DES:solid ratio and time on the effectiveness of DES1 (E200+1M FeCl₃) on leaching of an E-waste sample comminuted using a hammer mill to achieve a <2.0 mm sized fraction after passing through a range of wedge bar screens ranging from 50 mm to 2.0 mm. A typical assay of the resulting material can be seen in Table 9, which was collected using ICP-MS (Thermo Scientific™ iCAP™q_c Quadrupole ICP-MS, with a Cetac™ ASX520 Autosampler using Qtegra™ software version 2.10.3324.131).

TABLE 9
Assay data of <2.0 mm E-waste material

| Element | Concentration/ppm |
|---|---|
| Cu | 8827 |
| Fe | 47367 |
| Ag | 11.6 |
| Sn | 1530 |
| Zn | 650 |
| Au | 70 |

Recovery of the metals from this <2.0 mm E-waste material was explored via a series of trials conducted on ˜10.0 g samples of the E-waste material. In all cases the DES formulation E200+1M FeCl₃ was used. The baseline wt % of water, i.e. the amount of water in the DES formulation before water addition, was measured to be 2.0 wt %. The additional 14 wt % water was added gravimetrically to the pre-made E200+1M FeCl₃ and stirred using a magnetic stirrer at room temperature for 5 minutes. Total water content was measured using a Mettler Toledo® Titrator Compact V20S volumetric Karl Fischer Titrator.

This study was conducted using a matrix as described in Table 10. Analysis was conducted using ICP-MS as described in Example 2. Values greater than 100% are due to small sample heterogeneity. The process was conducted using a 250 mL round bottom flask with stirring from a magnetic stirrer using a Radley's Carousel 6 Plus™ System 34.

TABLE 10
DES trials to compare a range of process parameters.

| | Experimental Parameters | | | | | | | | |
|---|---|---|---|---|---|---|---|---|---|
| | DES:Solid | Time/ | Water | Temp/ | Element/Total Leached % | | | | |
| | v/w | hr | weight % | ° C. | Cu | Zn | Sn | Ag | Au |
| EW005 | 5:1 | 4 | 2 | 40 | 62.7 | 40.7 | 62.3 | 61.1 | <0.1 |
| EW006 | 5:1 | 4 | 16 | 80 | 82.3 | 61.6 | 109.6 | 73.4 | <0.1 |
| EW007 | 5:1 | 24 | 2 | 80 | 106.9 | 47.3 | 108.9 | 77.0 | <0.1 |
| EW008 | 5:1 | 24 | 16 | 40 | 92.1 | 52.7 | 127.9 | 86.7 | <0.1 |
| EW009 | 15:1 | 4 | 2 | 80 | 100.6 | 123.8 | 122.9 | 92.2 | <0.1 |
| EW010 | 15:1 | 4 | 16 | 40 | 108.1 | 104.9 | 96.7 | 110.8 | <0.1 |
| EW011 | 15:1 | 24 | 2 | 40 | 108.4 | 113.5 | 147.7 | 100.2 | <0.1 |
| EW012 | 15:1 | 24 | 16 | 80 | 102.9 | 107.4 | 107.8 | 104.7 | <0.1 |

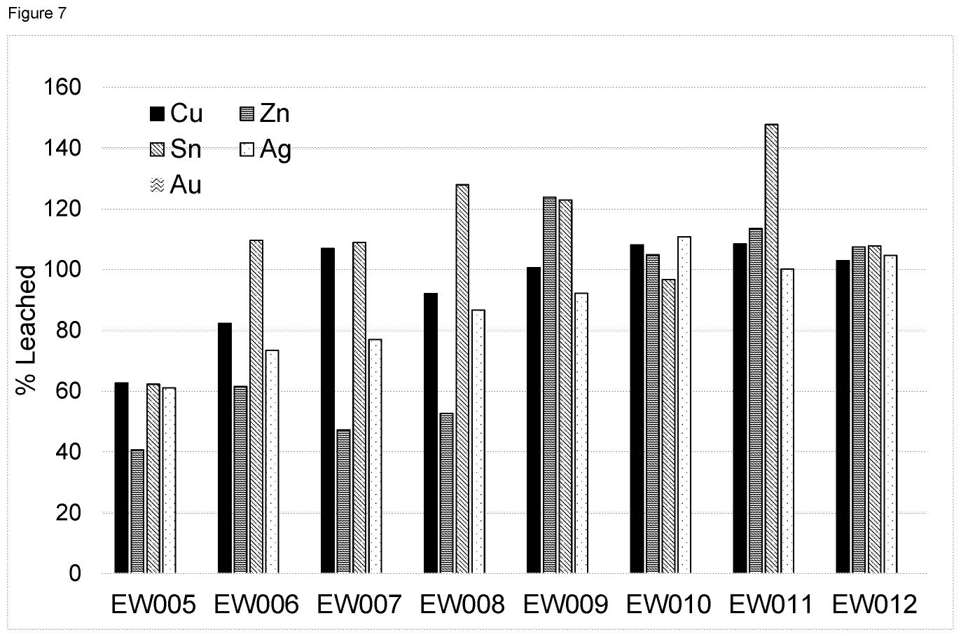

As can be seen from Table 10 and FIG. 7, no Au was leached under any of the conditions. High amounts of Cu, Zn, Sn and Ag were leached under all conditions. Zn leaching appeared to be the most sensitive to the changing conditions. Raising the temperature and increasing the leaching time improved leaching percentages.

### Example 5—Two-Stage Leaching Process Performed on Comminuted E-Waste

### Pre-Treatment of Electronic Waste Prior to Extraction

Comminution of the electronic waste material: The material was comminuted to a particle size of below 1.2 mm.

Removal of steel: Steel was removed by magnetic separation techniques.

### Extraction Using Deep Eutectic Solvents

Stage 1 Leach: Electronic waste solid material containing copper, nickel, tin, lead, silver and gold was sent into the first leach tank in which it was contacted with a DES formed from choline chloride (1 mol. equiv.) and ethylene glycol (2 mol. equiv.), with FeCl₃ (1 mol dm⁻³) as the oxidiser. The ratio of DES+FeCl₃ to solid material was 15:1 w/w. Contacting the solid material with the DES+FeCl₃ formulation at 80° C. for 24 hrs resulted in efficient metal recoveries: Cu: 99.7%, Ni: 99%, Sn: 92%, Pb: 98%, Ag: 99%. 0% Au is leached using this formulation, resulting in an Au-rich solid material. The leached solid material from this stage was filtered, washed and dried. The liquid phase comprising the leached metals was transferred to a separate tank for metal recovery.

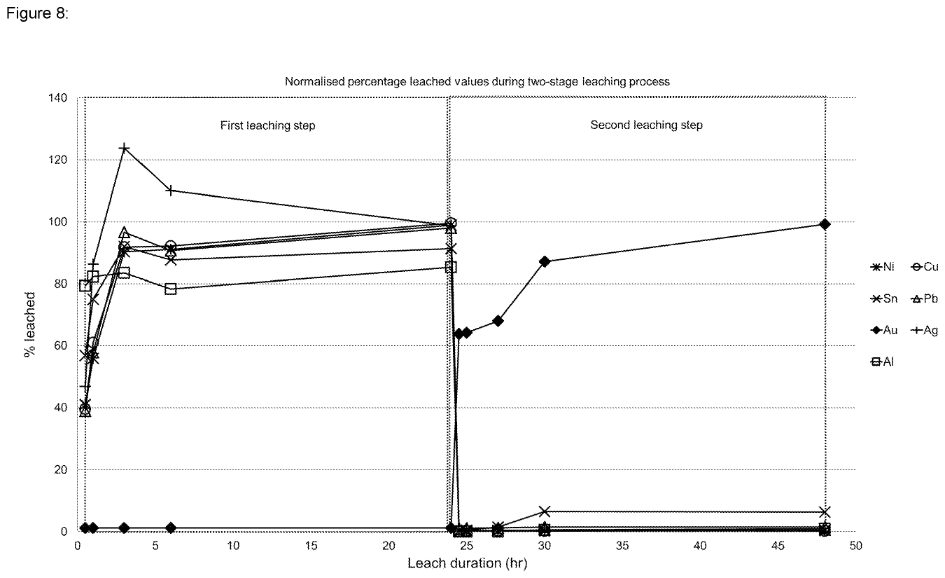

Stage 2 Leach: The cleaned and dried leached solid material was transferred into a second leach tank in which it was contacted with a DES formed from choline chloride (1 mol. equiv.) and ethylene glycol (2 mol. equiv.), with I₂ (0.5 mol dm⁻³) as the oxidiser. The ratio of DES+I₂ to solid material was 3:1 w/w. The purpose of this second leach is to recover Au from the solid material. Contacting the solid material with the DES+I₂ formulation at 80° C. for 24 hrs resulted in 99% Au recovery and was also able to recover any residual metals contained within the solid residue. The leached solid material from this stage was filtered, washed and sent for waste. The liquid phase comprising the leached metals was transferred to a separate tank for metal recovery. Data from this leaching process can be seen in FIG. 8.

1. A process for the extraction of one or more metals from a solid material, the process comprising:
(i) a first leaching step comprising contacting the solid material with a first leaching solution comprising:
a first deep eutectic solvent (DES) formed by the reaction of a first quaternary ammonium salt and a first hydrogen bond donor in a molar ratio of from 4:1 to 1:20; and,
a first oxidiser,
thereby providing a first leached solid material and a first liquid phase;
(ii) a second leaching step comprising contacting the first leached solid material with a second leaching solution comprising:
a second DES formed by the reaction of a second quaternary ammonium salt and a second hydrogen bond donor in a molar ratio of from 4:1 to 1:20; and,
a second oxidiser,
thereby providing a second leached solid material and a second liquid phase;
wherein the first oxidiser and the second oxidiser are different.

2. The process according to claim 1, wherein the first and the second oxidiser have different reduction potentials.

3. The process according to claim 1, a wherein the reduction potential of the second oxidiser is more positive than the reduction potential of the first oxidiser.

4. The process according to claim 1, wherein the reduction potential of the first oxidiser is less than or equal to +0.50V, preferably from −1.00 V to +0.50 V.

5. The process according to claim 1, wherein the reduction potential of the second oxidiser is greater than or equal to +0.50 V, preferably from +0.50 V to +2.0 V.

6. The process according to claim 1, wherein the first oxidiser cannot oxidise Au(0).

7. The process according to claim 1, wherein the second oxidiser oxidises Au(0).

8. The process according to claim 1, wherein the first oxidiser is an Fe(III) salt, a Cu(II) salt, a Te(IV) salt, a Cr(III) salt, or a Mn(VII) salt, preferably an Fe(III) salt or a Cu(II) salt, more preferably an Fe(III) salt.

9. The process according to claim 1, wherein the first oxidiser is FeCl₃, FeF₃, FeBr₃, FeI₃, Fe(CN)₆, Fe(SCN)₃, Fe(NO₃)₃, Fe(SO₄)₃, Fe(OH)₃, Fe(C₂H₃O₂)₃, CuCl₂, CuF₂, CuBr₂, CuI₂, Cu(NO₃)₂, CuSO₄, CuO, Cu(OH)₂, TeCl₄, TeF₄, TeBr₄, TeI₄, TeO₂, or KMnO₄, more preferably wherein the first oxidiser is FeCl₃ or CuCl₂, even more preferably wherein the first oxidiser is FeCl₃.

10. The process according to claim 1, wherein the second oxidiser is I₂ or SeCl₄, SeF₄, SeBr₄, SeI₄, SeO₂, preferably wherein the second oxidiser is I₂.

11. The process according to claim 1, wherein the first and second quaternary ammonium salts are each independently a compound of Formula (I): 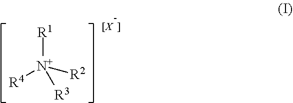
wherein R¹, R², R³, and R⁴ are each independently: H; a substituted or unsubstituted C₁-C₈ alkyl group; a substituted or unsubstituted C₆-C₁₀ cycloalkyl group; a substituted or unsubstituted C₆-C₁₂ aryl group; a substituted or unsubstituted C₇-C₁₂ alkaryl group; or,
wherein R¹ and R², taken together with the N atom to which they are attached, form a substituted or unsubstituted 5 to 11-membered ring, and R³ and R⁴ are as defined earlier;
wherein X⁻ is NO₃⁻, F⁻, Cl⁻, Br⁻, I⁻, BF₄⁻, ClO₄⁻, SO₃CF₃⁻, bitartrate, dihydrogen citrate, or, COOCF₃⁻, and,
wherein substituted means that the group may be substituted with one or more of the groups selected from: OH, SH, SR⁵, Cl, Br, F, I, NH₂, CN, NO₂, COO⁻, COOR⁵, CHO, COR⁵, and OR⁵, wherein R⁵ is H, a C₁-C₁₀ alkyl or a C₁-C₁₀ cycloalkyl group.

12. The process according to claim 1, wherein the first and second quaternary ammonium salts are each independently choline chloride, choline hydroxide, choline acetate, choline bitartrate, choline dihydrogencitrate, betaine, betaine HCl, ammonium chloride, methylammonium chloride, ethylammonium chloride, tetra-butylammonium chloride, or ethanolamine hydrochloride, preferably wherein the first and second quaternary ammonium salts are choline chloride.

13. The process according to claim 1, wherein the first and second hydrogen bond donors are each independently a compound of the formula R⁶COOH, R⁷R⁸NH, R⁹CZNH₂, R¹⁰OH, or HO—R¹¹—OH wherein:
R⁶, R⁷, R⁸, and R¹⁰ are each independently H; a substituted or unsubstituted C₁-C₈ alkyl group; a substituted or unsubstituted C₁-C₈ alkenyl group; a substituted or unsubstituted aryl group; or a substituted or unsubstituted C₇-C₁₂ alkaryl group; and R¹¹ is a substituted or unsubstituted C₁-C₁₁ alkyl group
wherein substituted means that the group may be substituted with one or more groups selected from OH, SR₅, Cl, Br, F, I, NH₂, CN, NO₂, 3,4-dihydroxy-2H-furan-5-one, CONR⁵,COOR⁵, COR⁵ and OR⁵, wherein R⁵ is H, a C₁ to C₁₀ alkyl or a C₁-C₁₀ cycloalkyl group;
R⁹ is a group as defined for R⁶, or NHR¹², wherein R¹² is H or a C₁-C₆ alkyl group; and, Z is O or S
R¹¹ is a substituted or unsubstituted C₁-C₁₁ alkyl group

14. The process according to claim 1, wherein the first and second hydrogen bond donors are each independently ethylene glycol, glycerol, 1,2-propanediol, 1,3-propandiol, 1,4-butandiol, 1,5-pentandiol, urea, oxalic acid, malonic acid, levulinic acid, lactic acid, citric acid, maleic acid, malonamide, acetamide, oxalic acid dihydrate, ascorbic acid, glutaric acid, glycolic acid, mandelic acid, succinic acid, tartaric acid or phenol, preferably wherein the first and second hydrogen bond donors are ethylene glycol.

15. The process according to claim 1, wherein the molar ratio of first quaternary ammonium salt to the first hydrogen bond donor is from 4:1 to 1:20, preferably 2:1 to 1:4.

16. The process according to claim 1, wherein the molar ratio of second quaternary ammonium salt to the second hydrogen bond donor is from 4:1 to 1:20, preferably 2:1 to 1:4.

17. The process according to claim 1, wherein the first oxidiser is present at a concentration of 0.001 mol dm⁻³ to 2.5 mol dm⁻³, preferably 1 mol dm⁻³.

18. The process according to claim 1, wherein the second oxidiser is present at a concentration of 0.001 mol dm⁻³ to 1.5 mol dm⁻³, preferably 0.5 mol dm⁻³.

19. The process according to claim 1, wherein, in the first leaching step, the ratio of DES plus the first oxidiser to metal in the solid material is from 1:50 to 100:1 (w:w).

20. The process according to claim 1, wherein, in the second leaching step, the ratio of DES plus second oxidiser to metal in the solid material is 1:50 to 100:1 (w:w).

21. The process according to claim 1, wherein, in the first leaching step, the ratio of DES to solid material is from 1:50 to 100:1 (v/w).

22. The process according to claim 1, wherein, in the second leaching step, the ratio of DES to solid material may be from 1:50 to 100:1 (v/w).

23. The process according to claim 1, wherein, in the first and second leaching steps, the solid material is leached at a temperature of 10° C. to 120° C. for 5 minutes to 240 hours.

24. The process according to claim 1, wherein the first and second quaternary ammonium salts are each independently choline chloride, choline hydroxide, choline acetate, choline bitartrate, choline dihydrogencitrate, betaine, betaine HCl, ammonium chloride, methylammonium chloride, ethylammonium chloride, tetra-butylammonium chloride, or ethanolamine hydrochloride; preferably wherein the first and second quaternary ammonium salts are choline chloride;
wherein the first and second hydrogen bond donors are each independently ethylene glycol, glycerol, 1,2-propanediol, 1,3-propandiol, 1,4-butandiol, 1,5-pentandiol, urea, oxalic acid, malonic acid, levulinic acid, lactic acid, citric acid, maleic acid, malonamide urea, acetamide, oxalic acid dihydrate, ascorbic acid, glutaric acid, glycolic acid, mandelic acid, succinic acid, tartaric acid or phenol, preferably wherein the first and second hydrogen bond donors are ethylene glycol;
wherein the molar ratios of the first and second quaternary ammonium salts to the first and second hydrogen bond donors are preferably from 4:1 to 1:20, more preferably 2:1 to 1:4;
wherein the reduction potential of the first oxidiser is less than or equal to +0.50 V, preferably wherein the first oxidiser is FeCl₃; and,
wherein the reduction potential of the second oxidiser is greater than or equal to +0.50 V, preferably wherein the second oxidiser is I₂.

25. The process according to claim 1, wherein the first and second quaternary ammonium salts are choline chloride; the first and second hydrogen bond donors are ethylene glycol; the molar ratios of the first quaternary ammonium salt to the first hydrogen bond donor and the second quaternary ammonium salt to the second hydrogen bond donor are 1:2; the reduction potential of the first oxidiser is less than or equal to +0.50 V and/or the first oxidiser is an Fe(III) salt, or a Cu(II) salt, preferably an Fe(III) salt; and, the reduction potential of the second oxidiser is greater than or equal to +0.50 V and/or the second oxidiser is I₂.

26. The process according to claim 1, further comprising a step of:
recovering one or more metals from the first liquid phase; and/or,
recovering one or more metals from the second liquid phase.

27. The process according to claim 1, further comprising filtering, cleaning and drying the first leached solid material before the second leaching step.

28. A process for the extraction of one or more metals from a solid material, the process comprising:
(i) a leaching step comprising contacting the solid material with a leaching solution comprising:
a deep eutectic solvent (DES) formed by the reaction of a quaternary ammonium salt and a hydrogen bond donor in a molar ratio of from 4:1 to 1:20; and,
a first oxidiser;
wherein the reduction potential of the first oxidiser is less than or equal to +0.50V and/or wherein the first oxidiser is an Fe(III) salt, a Cu(II) salt, a Te(IV) salt, a Cr(III) salt, or a Mn(VII) salt.

29. A composition for leaching one or more metals from a solid material comprising:
a deep eutectic solvent formed by the reaction of a first quaternary ammonium salt and a first hydrogen bond donor in a molar ratio of 4:1 to 1:20; and
a first oxidiser;
wherein the reduction potential of the first oxidiser is less than or equal to +0.50V and/or wherein the first oxidiser is an Fe(III) salt, a Cu(II) salt, a Te(IV) salt, a Cr(III) salt, or a Mn(VII) salt.
